(19) United States
(12) Patent Application Publication
(10) Pub. No.: US 2006/0086732 A1
(43) Pub. Date: Apr. 27, 2006

(54) Heater with storage device

(76) Inventor: Eric Martinez, Romans Sur Isere (FR)

Correspondence Address: CLARK & BRODY, 1090 VERMONT AVENUE, NW, SUITE 250, WASHINGTON, DC, 20005, US

(21) Appl. No.: 11/233,133

(22) Filed: Sep. 23, 2005

(30) Foreign Application Priority Data
Sep. 23, 2004 (FR) 0410047

(51) Int. Cl. H05B 6/64

(52) U.S. Cl. 219/678

(57) ABSTRACT

The invention relates to an electric heating device comprising a casing, at least one heat storage block in a refractory material, fitted with at least one electric resistor and positioned inside the casing and means for supplying the electric resistor with electricity, characterized in that it further comprises at least one heat diffuser in a heat conducting material which is placed inside the casing in contact with the storage block and which is conformed in order to define, in association with the casing, at least one air flow channel in order to provide diffusion of heat by convection and which has a surface area larger than that of one of the main faces of the storage block, in order to provide diffusion of heat by radiation.

The present invention relates to the technical field of individual electric heating devices used for heating residential premises or offices.

In the above field, it is known how to apply electric convectors which comprise a hollow casing, provided with high and low apertures, and inside which an electric resistor is positioned, possibly associated with fins. As indicated by its name, an electric convector provides heating of ambient air by a convection phenomenon, during which air is heated when contacting the electric resistor or fins which are associated with it. If, with such devices, the temperature of a room may be raised relatively quickly by bringing the air of the latter to the sought-after temperature, they however have the drawback of not providing comfortable heat, such as the heat emitted by a water radiator system notably. It was seen that this poorer comfort quality came from the fact that the convectors do not hardly diffuse any heat by infrared radiation, radiation which is at the origin of the feeling of comfort for the user. Moreover, it appeared that electric convectors did not have an optimum thermoelectric efficiency and were the cause of a relatively large consumption of electricity.

In order to find a remedy to the latter drawback, what should be called electrical storage heaters were suggested. Such radiators comprise a large number of refractory ceramic heat storage blocks, fitted with electric resistors. Thus, during periods, the so-called off-peak hours, the storage blocks are heated by electric resistors and store calories. Subsequently, after turning off the electric power supply, the radiator diffuses by convection and radiation, the heat stored in the storage blocks. With such devices, it is actually possible to obtain diffusion of heat by radiation and by convection. However, they have the drawback of being relatively bulky and heavy, because of the large number of storage blocks which they contain, so that their installation is not always easy and they are unsuitable for small space residential premises.

In order to find a remedy to the drawbacks of electric convectors, on the one hand, and of storage heaters, on the other hand, what should be called heat-inertia electric radiators were suggested. The invention more particularly relates to this type of electric heating device which applies a heat storage block of smaller dimensions than the blocks of storage heaters and which allows a heat storage buffer to be formed, avoiding surges in electric power consumption and, allowing substantial increase in the efficiency of this type of electric heating devices to be obtained consequently, as compared with an electric convector of equivalent electrical power.

In the field of inertial electric heaters, it is known how to produce the latter by taking an aluminum structure of a water radiator and by laying out, inside the latter, a recess for placing the storage block. If such an embodiment seems to be satisfying, it appeared that it was possible to improve the design of heat-inertia radiators, notably in order to increase their capability of providing diffusion of heat by radiation, while retaining a capability of diffusing heat by convection.

In order to achieve this goal, the invention relates to an electrical heating device comprising:
a casing,
at least one heat storage block in a refractory material fitted with at least one electrical resistor and positioned inside the casing,
and means for supplying electricity to the electrical resistor.

According to the invention, the electrical heating device is characterized in that it further comprises at least one heat diffuser in a heat conducting material which is placed inside the casing in contact with the storage block and which is conformed in order to define, in association with the casing, at least one air flow channel, so as to provide diffusion of heat by convection, and which has a surface area larger than that of the main faces of the storage block, to provide diffusion of heat by radiation.

Application of such a heat diffuser, and the intimate contact between the latter and the storage block, allows heat to be transmitted by conduction to the diffuser which then provides its diffusion in the environment to be heated, both by convection and by radiation.

According to the invention, the heating device may be produced in different ways in order to, for example, form a mobile device, such as for example an auxiliary heater which may be moved according to requirements.

However, in a preferred application, the electric heating device according to the invention is intended to be permanently installed against a support, such as for example a partition or wall.

Thus, in a preferred embodiment, the casing has a back fitted with means for hanging it on a support and, opposite the back, a front. The heat diffuser in then interposed between the front and the storage block.

In a preferred embodiment, the casing at the front will then have a wall transparent to infrared rays, such as for example, a wall in a special glass or plastic, this wall may have patterns or colors giving a decorative function to the heating device according to the invention.

In a preferred but non-exclusive embodiment, the electric heating device comprises two heat diffusers which are positioned on either side of the storage block while being in contact with the latter and interposed between the storage block and the casing and which define, by their opposite faces, at least one air flow channel.

According to another feature of the invention, in order to promote diffusion of heat by radiation, without however cancelling diffusion of heat by convection, each diffuser is conformed so that the air flow channel, defined in connection with the casing, has at least one bend for slowing down the air convection stream.

According to another feature of the invention, each diffuser is conformed in order to have an alternation of concave and convex conformations which define, as seen from the large face of the diffuser opposite to the contact face of the diffuser with the storage block, herringbone-shaped channels which converge towards the centre of the large face of the diffuser and the branches of which diverge towards the sides of the large face of the diffuser.

With such a conformation of diffusers, it is thereby possible to increase their radiant surface and obtain a more homogenous temperature of the surface of the diffuser.

According to another feature of the invention, in order to guarantee the quality or the intimacy of the contact of each diffuser with the storage block, the large face of each diffuser, located in contact with the storage block, has a relief imprint for pressing onto the storage block. With such a feature of the invention, heat transmission by conduction from the storage block to the diffuser may be optimized.

According to another further feature of the invention, the heat storage block has a rectangular parallelipipedous shape and two large front and rear faces, respectively. The front and rear faces each have grooves for receiving an electric resistor length notably for promoting diffusion of heat by radiation. The grooves of the front face of the storage block are then made so as to allow the placement of an electrical resistor length larger than the electric resistor length present on the rear face.

According to another feature of the invention and in order to take convection phenomena into account and to obtain larger uniformity of the temperature of the front diffuser, the front face of the storage block has in its low portion, an electric resistor length larger than the electric resistor length present in the high portion of said front face.

According to another feature of the invention and to provide air flow inside the heating device, the casing in the high and low portion, has vents for letting through air and the storage block is surrounded by a protective frame against liquid tricklings.

Various other features of the invention will become apparent from the above description made with reference to the drawings which illustrate a preferred but non-limiting embodiment of an electric heating device according to the invention.

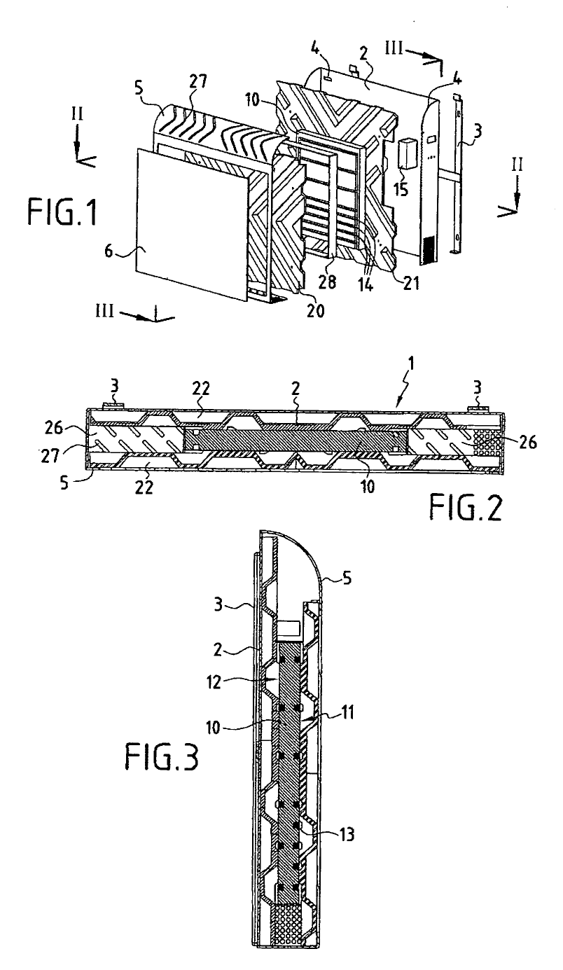

FIG. 1 is an exploded perspective view of an electric heating device according to the invention.

FIG. 2 is a section along the II-II plane of FIG. 1, of the heating device according to the invention in an assembled condition.

FIG. 3 is a section along the III-III plane of FIG. 1, of the electric heating device also in an assembled condition.

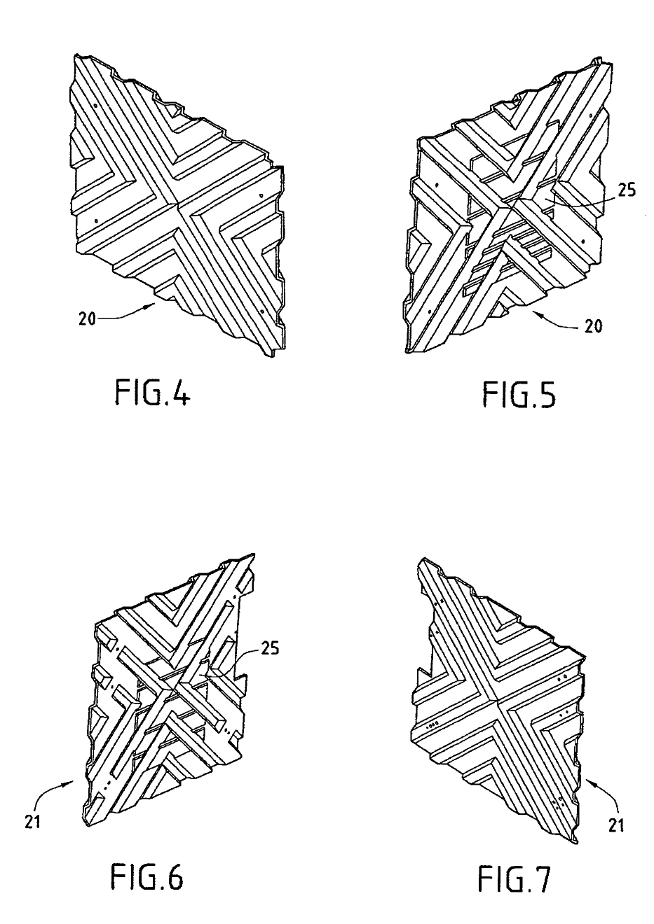

FIG. 4 is a perspective view from its front face, of a diffuser before its application within the framework of the electric heating device illustrated in FIG. 1.

FIG. 5 is a rear perspective view of the front diffuser as illustrated in FIG. 4.

FIG. 6 is a view from the front face of the constitutive rear diffuser of the electric heating device illustrated in FIG. 1.

FIG. 7 is a rear perspective view of the rear diffuser, as illustrated in FIG. 6.

An electric heating device according to the invention, such as illustrated in FIGS. 1 to 3, comprises a casing 1, inside which various constitutive components of the heating device are positioned. According to the illustrated example, the electric heating device is intended to be placed as a fixture against a wall or a partition, and for this purpose has a back 2 fitted with means 3 for hanging it on a support, not shown. According to the illustrated example, the back 2 is made in folded sheet metal and has two windows 4, intended to cooperate with the means 3 for example forming a hanging chair capable of being fixed against a wall. The casing 1 also comprises a front face 5, of course located opposite to the back 2. According to the illustrated example, the front face 5 is also made in sheet metal and is found to be conformed, when it is assembled with the back 2, for defining a partially closed volume, inside which the other constitutive components of the electric heating device are positioned, in order to place them out of direct reach.

It should be noted that in the preferred embodiment, the front 5 of the casing 1 has a wall 6 transparent to infrared rays and which may be made in ground glass for example. Of course, any other material may be contemplated for the front face wall 6, insofar that the retained material will be able to let through infrared radiations at least partly.

According to an essential feature of the invention, the electric heating device also comprises at least one and according to the illustrated example, exactly one heat storage block 10, intended to give certain heat inertia to the heating device.

The storage block 10 may be made in any suitable refractory material and, according to the illustrated example, it consists of a rectangular parallelepipedous block of refractory ceramic with a rather flattened shape, so as to have two main large front 11 and rear 12 faces. The storage block 10 is further fitted with an electric resistor 13 placed in the grooves 14 made in the front 11 and rear 12 faces of block 10.

In the illustrated embodiment and without this here being a feature strictly required for producing a heating device according to the invention, the grooves 14 of the front face 11 of the storage block 12 are made so as to allow the placement of an electric resistor length 13 larger than the electric resistor length present on the rear face 12. With this advantageous feature of the invention, diffusion of heat by radiation may then be promoted, as this will appear subsequently.

Also, in order to take convection phenomena into account involved in the casing 1, the front face 11 of the storage block 10 in its low portion, has an electric resistor length larger than the electric resistor length present in the high portion of this same front face 11. For this purpose, it will be noted that the front face 11 of the block 10 in its lower portion has five horizontal grooves 14 with identical lengths for receiving a resistor length whereas the upper or high portion of the face 11 only has three horizontal grooves of the same length as the grooves of the low portion.

The electric resistor 13 will further be supplied with electricity by a control block 15 for example integrating a thermostat providing control of the temperature of the storage block 10, and consequently, of the temperature of the room inside which the electric heating device according to the invention is positioned.

According to another essential feature of the invention, the electric heating device also comprises at least one and according to the illustrated example, two front 20 and rear 21 heat diffusers, which are positioned on either side of the storage block 10 while being in contact with the latter, as more particularly shown in FIGS. 2 and 3.

Thus, each diffuser 20, 21 is conformed in order to define, in association with the casing 1, at least one air flow channel, in order to provide diffusion of heat by convection. Further, the diffusers 20, 21 are made so as to have a surface area larger than that of one of the main faces of the storage block 10, in order to provide diffusion of heat by radiation.

As shown in FIGS. 4 to 7, each diffuser has the general shape of a rectangular plate, conformed in order to have alternation of concave and convex conformations which provide a dual function.

Indeed, with these concave and convex formations of each of the diffusers 20, 21, by interposition of each diffuser between the corresponding wall of the casing 1 and the storage block 10, it is possible to avoid direct contact of the storage block 10 with the corresponding face with the casing and to thereby prevent a too high temperature of the casing when operating the heating device according to the invention.

Further, the alternation of convex and concave conformations of each diffuser in association with the corresponding portion of the casing, allows at least one channel 22 for air flow to be defined, in order to provide diffusion of heat by convection and to limit the rise in temperature of the external wall of the casing 1.

According to the preferred embodiment, the alternation of concave and convex conformations on the large face of each diffuser opposite to the contact face of each diffuser with the storage block, as illustrated in FIGS. 4 and 6, defines herringbone-shaped channels which converge towards the centre of the large face of the diffuser and the branches of which diverge towards the sides. Thus, as shown in FIGS. 4 and 6, the alternation of convex and concave conformations defines “V-shaped” channels, the branches of which converge from the four sides of the diffuser towards the centre of the latter.

This radial configuration aims at providing better homogeneity of the temperature of the diffusers. Further, the “V-shaped” herringbones define with the corresponding portion of the casing, channels which have at least one bend for slowing down the convection air flow. This advantageous configuration of the invention thereby limits convection phenomena, at least at the face of the diffuser in contact with the casing and notably, at the contact face of the front diffuser 20 with the front face wall 6 of the casing 1.

According to the invention, in order to guarantee the quality of the contact, between the diffusers 20, 21 and the storage block 10, each diffuser at its large face intended to be in contact with the storage block, has a relief imprint 25 for pressing against and optimally contacting the storage block 10.

In the heating device according to the invention, the storage block 10 is then placed between the front 20 and rear 21 diffusers which are thus interposed between the block 10 and the corresponding portion of the casing, i.e., the front face 5 and the back 2. Further, in this configuration, the faces opposite to the diffusers 20 and 21 define two air flow channels 26 for diffusing heat from the block 10 by convection; For this purpose, the casing 1 has vents 27 which, according to the illustrated example, are laid out on the high and low portions of the front face 5, so as to allow flow through the casing 1 and provide diffusion of heat from the storage block 10 by convection.

It should be noted that, taking the presence of the vents 27 into account, the device according to the invention further comprises a frame 28 intended to provide a protection of the block 10 and of the resistor 13 against tricklings or projections of liquids which may occur through the vents 27 laid out in the high portion of the casing 1.

The design of the electric heating device according to the invention has the advantage of allowing diffusion of heat by convection, while promoting diffusion of heat by radiation, so that the electric heating device according to the invention provides very high comfort quality. Further, by applying the storage block, it is possible to give to the heating device a certain inertia which avoids powering too frequently the electric resistor and thus energy servings may be obtained while increasing the thermoelectric efficiency of the device.

Of course, it may be emphasized that various changes may be made to the general design of the heating device according to the invention, and this without departing from the scope of the present invention.

1. An electric heating device comprising:
a casing,
at least one heat storage block in a refractory material, fitted with at least one electric resistor and positioned inside the casing,
and means for supplying the electric resistor with electricity,
characterized in that it further comprises at least one heat diffuser in a heat conducting material which is placed inside the casing in contact with the storage block and which is conformed in order to define, in association with the casing, at least one air flow channel in order to provide diffusion of heat by convection and which has a surface area larger than that of one of the main faces of the storage block, in order to provide diffusion of heat by radiation.

2. The electric heating device according to claim 1, characterized in that the casing has a back fitted with means for hanging it on a support and, opposite the back, a front face and in that the heat diffuser is interposed between the front face and the storage block.

3. The electric heating device according to claim 2, characterized in that the casing at the front face, has a wall transparent to infrared rays.

4. The electric heating device according to claim 1, characterized in that it comprises two heat diffusers positioned on either side of the storage block while being in contact with the latter and interposed between the storage block and the casing and which define at least one air flow channel with their faces facing one another.

5. The electric heating device according to claim 1, characterized in that each diffuser is conformed so that the air flow channel defined in connection with the casing, has at least one bend for slowing down the convection air stream.

6. The electric heating device according to claim 1, characterized in that each diffuser is conformed in order to have an alternation of concave and convex conformations which, as seen from the large face of the diffuser, opposite to the contact face of the diffuser with the storage block, define herringbone-shaped channels which converge towards the centre of the large face of the diffuser and the branches of which diverge towards the sides of the large face of the diffuser.

7. The electric heating device according to claim 1, characterized in that the large face of each diffuser, located in contact with the storage block, has a relief imprint for pressing onto the storage block.

8. The electric heating device according to claim 1, characterized in that the heat storage block has a rectangular parallelepipedous shape and two large front and rear faces, respectively, the front and rear faces each having grooves for receiving an electric resistor length and in that the grooves of the front face of the storage block are made so as to allow the placement of an electric resistor length larger than the electric resistor length present on the rear face.

9. The electric heating device according to claim 8, characterized in that the front face of the storage block in its low portion has an electric resistor length larger than the electric resistor length present in the high portion of said front face.

10. The electric heating device according to claim 1, characterized in that the casing at its high and low portions has vents for letting through air and in that the storage block is surrounded by a protective frame against liquid tricklings.
